(19) United States
(12) Patent Application Publication
(10) Pub. No.: US 2010/0083481 A1
(43) Pub. Date: Apr. 8, 2010

(54) Method for attaching magnesium panels using self-piercing rivet

(75) Inventors: Aihua A. Luo, Troy, MI (US); Anil K. Sachdev, Rochester Hills, MI (US)

Correspondence Address: GENERAL MOTORS LLC;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 12/247,387

(22) Filed: Oct. 8, 2008

(51) Int. Cl. B23P 11/00; B23K 11/10

(52) U.S. Cl. 29/432; 219/91.23

(57) ABSTRACT

A method for attaching an aluminum panel to a magnesium panel via a self-piercing rivet. The method includes positioning the aluminum panel and the magnesium panel together with the magnesium panel supported on an anvil having a cavity therein. The magnesium panel is spot heated at the locale of the anvil, and then the self-piercing steel rivet is punched through the steel panel and only partway into the magnesium panel, to displace the magnesium panel into the cavity. The heating of the magnesium improves the ductility so that the self-piercing rivet is accepted without undue strain on the magnesium material. The interface between the steel rivet and the magnesium panel is concealed between the aluminum panel and the magnesium panel to thereby protect the interface between the steel material of the rivet and the magnesium panel from exposure to the environment.

### FIELD OF THE INVENTION

The present invention relates to the joining together of a panel of aluminum and a panel of magnesium by a steel self-piercing rivet.

### BACKGROUND OF THE INVENTION

In modern motor vehicles it is desirable to construct the vehicle of non-ferrous materials such as aluminum and magnesium which exhibit low weight and accordingly contribute to improved fuel economy. It is known to attach metal panels together using self-piercing rivets that are made of steel.

The use of self-piercing rivets of a steel material is particularly challenging when the one of the panels to be joined is a magnesium panel because the exposure of the abutting steel and magnesium materials to the environment can set up conditions conducive to galvanic corrosion. In addition, the magnesium material is often not sufficiently ductile to readily accept the intrusion of a self-piercing rivet.

### SUMMARY OF THE INVENTION

According to the invention, a method is provided for using a steel self-piercing rivet to attach an aluminum panel to a magnesium panel. The method includes positioning the aluminum panel and the magnesium panel together with the magnesium panel supported on an anvil having a cavity therein. The magnesium panel is spot heated at the locale of the anvil, and then the self-piercing steel rivet is punched through the aluminum panel and only partway into the magnesium panel, to displace the magnesium panel into the cavity. The heating of the magnesium improves the ductility so that the self-piercing rivet is accepted without undue strain on the magnesium material. The interface between the steel rivet and the magnesium panel is concealed between the aluminum panel and the magnesium panel to thereby protect the interface between the steel material of the rivet and the magnesium panel from exposure to the environment.

### BRIEF DESCRIPTION OF THE DRAWINGS

FIG. 1 is a section view taken through an aluminum panel sitting atop a magnesium panel.

FIG. 2 shows the magnesium panel supported on an anvil heated by an induction coil and the steel self-piercing rivet being installed by a punch.

FIG. 3 shows the completed attachment of the aluminum panel to the magnesium panel by the self-piercing rivet.

FIG. 4 is a view similar to FIG. 2 but showing the heating of the magnesium panel by electric resistance heating of the tool.

### DETAILED DESCRIPTION OF THE EXEMPLARY EMBODIMENTS

The following description of certain exemplary embodiments is merely exemplary in nature and is not intended to limit the invention, its application, or uses.

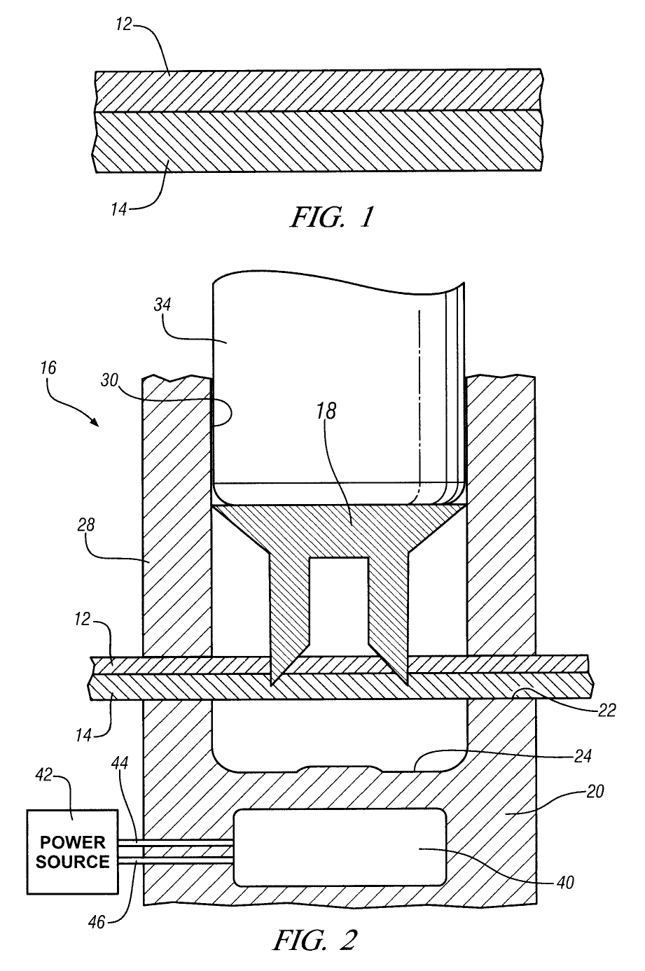

Referring to FIG. 1, an aluminum panel 12 is positioned atop a magnesium panel 14. Thus, the panels are ready to be joined together.

Referring to FIG. 2 the aluminum panel 12 and the magnesium panel 14 are shown in a tool 16 for installing a self-piercing rivet 18. The tool 16 includes a lower anvil 20 having a support surface 22 with a die cavity 24. The magnesium panel 14 rests upon the support surface 22. The tool 16 also includes an annular housing 28 which is annular in shape and locates and supports the self-piercing rivet 18. The annular housing 28 has a central bore 30 in which the rivet 18 is located and supported. A punch 34 is vertically movable within the bore 30 of the annular housing 28 for driving the self-piercing rivet 18 downwardly into the panels 12 and 14. In particular, as shown in FIG. 2, the rivet 18 pierces into the aluminum panel 12 and into the lower magnesium panel 14.

FIG. 2 also shows an induction heating coil 40 embedded in the anvil 20 beneath the die cavity 24 and connected to an external power source 42 by electrical conductors 44 and 46. Prior to driving the rivet 18 into the panels, the induction heating coil 40 is energized to rapidly heat the magnesium panel 14 to a temperature of about 200 degrees Centigrade to improve the ductility of the magnesium panel 14. This improvement in ductility ensures that the magnesium can be pierced by the rivet and displaced into the cavity 24 of the anvil 20 without undue strain that may result in a tearing of the magnesium material. Although FIG. 2 shows an induction heating coil, the heater can be an electric resistance heater, in which case the anvil 20 can be held at a high temperature to transfer heat into the magnesium panel when the magnesium panel rests upon the support surface 22.

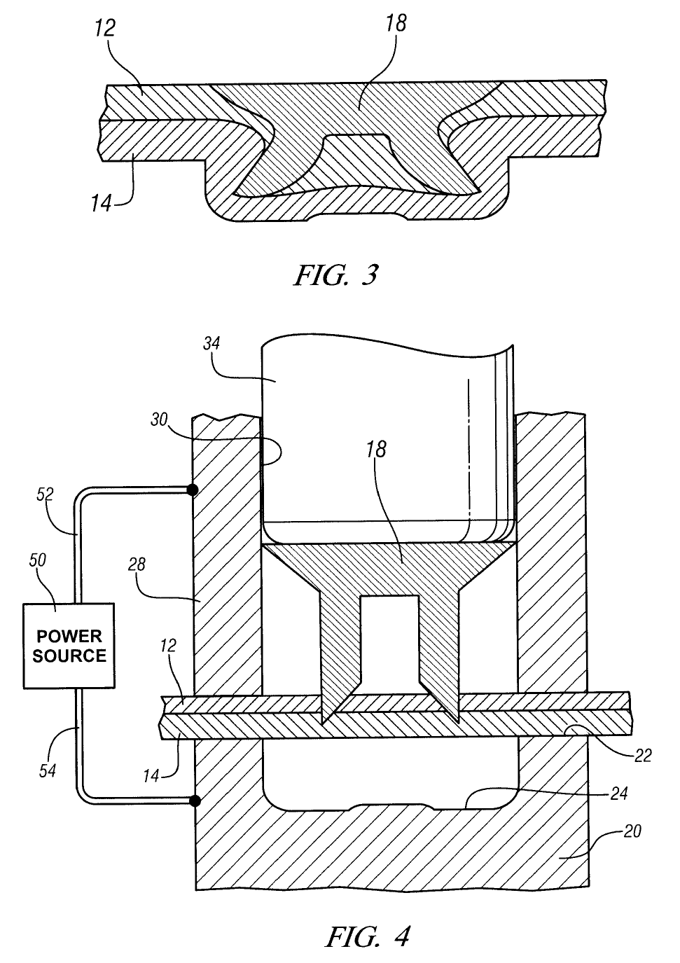

FIG. 3 shows the completed attachment in which the self-piercing rivet 18 has been driven completely through the upper aluminum panel 12 but only partway into the thickness of the lower magnesium panel 14. Accordingly, the magnesium panel 14 has been displaced downwardly into the cavity 24. Referring again to FIG. 3 it is seen that the interface and contact between the steel material of the steel rivet 18 and the magnesium material of the magnesium panel 14 occurs only in the sealed space that is enclosed between the confines of the aluminum panel 12 and the magnesium panel 14. Accordingly, the interface is not in any way exposed to the environment and thereby moisture or other conditions that would create a galvanic corrosive possibility is avoided.

Referring to FIG. 4 another embodiment of the invention is shown where the magnesium panel 14 is heated by electric resistance heating. In particular, an external power source 50 is connected to the annular housing 28 by an electrical conductor 52 and also connected to the anvil 20 by an electrical conductor 54. The power source, similar to that of an electric resistance welder, is energized briefly prior to driving the rivet 18 into the panels, so that the magnesium panel 14 is heated sufficiently to improve its ductility. The resistance heating can be accomplished either by passing the electric current through the annular housing 28, as shown, or through the punch 34 to the rivet 18. In either case, the electric current will pass through the aluminum panel and the magnesium panel to heat the magnesium panel and thereby improve its ductility.

The foregoing description of the invention is merely exemplary in nature and thus variations thereof are intended to be within the scope of the invention. Although the foregoing example is of attaching an aluminum panel to a magnesium panel, it will be understood that two magnesium panels can be attached together by using coated steel rivet is used so that there is no contact between the steel material of the rivet and the magnesium material of the magnesium panels. Furthermore, the invention can also be employed when attaching together more than two panels. Also, if desired, both electric resistance heating and induction heating can be employed to optimize the heating of the magnesium.

What is claimed is:

1. A method to attach a metal panel to a magnesium panel comprising:
positioning the metal panel and the magnesium panel together with the magnesium panel supported on an anvil having a die cavity therein;
spot heating the magnesium panel in the locale of the anvil to improve the ductility of the magnesium panel in the locale of the anvil;
punching a self-piercing rivet through the metal panel and only part way into the magnesium panel, thereby displacing the spot heated magnesium into the die cavity and attaching together the panels.

2. The method of claim 1 further comprising the spot heating being performed by an induction heating coil associated with the anvil.

3. The method of claim 1 further comprising the spot heating being performed by an induction heating coil embedded in the anvil beneath the die cavity.

4. The method of claim 1 further comprising the spot heating being performed by a resistance electric heater embedded in the anvil beneath the die cavity.

5. The method of claim 1 further comprising the spot heating being performed by conducting electric current through the aluminum panel and the magnesium panel at the spot to be heated.

6. The method of claim 1 further comprising the punching of the rivet being performed by a punch movable in an annular housing and the spot heating of the magnesium panel being performed by conducting electric current to the anvil and to either the annular housing or the punch so that electric current is conducted through the metal panel and the magnesium panel.

7. The method of claim 1 further comprising the spot heating of the magnesium panel to a temperature of about 200 degrees Centigrade to improve the ductility of the magnesium panel.

8. The method of claim 1 further comprising said metal plate being magnesium and said rivet being of coated steel so that the coating isolates the steel of the rivet from the magnesium of the metal panel to prevent galvanic corrosion therebetween.

9. The method of claim 1 further comprising said rivet being uncoated steel and the metal panel is aluminum and the interface between the steel rivet and the magnesium panel being concealed between the aluminum panel and the magnesium panel and thereby protected from corrosion inducing environmental exposure.

10. A method to attach an aluminum panel to a magnesium panel comprising:
positioning the aluminum panel and the magnesium panel together with the magnesium panel supported on an anvil having a die cavity therein;
spot heating the magnesium panel in the locale of the anvil to improve the ductility of the magnesium panel in the locale of the anvil;
punching a steel self-piercing rivet through the aluminum panel and only part way into the magnesium panel, thereby displacing the spot heated magnesium into the die cavity and attaching together the panels with the interface between the steel rivet and the magnesium being concealed between the steel panel and the magnesium panel and protected from corrosion inducing environmental exposure.

11. The method of claim 10 further comprising the spot heating being performed by an induction heating coil associated with the anvil.

12. The method of claim 10 further comprising the spot heating being performed by an induction heating coil embedded in the anvil beneath the die cavity.

13. The method of claim 10 further comprising the spot heating being performed by a resistance electric heater embedded in the anvil beneath the die cavity.

14. The method of claim 10 further comprising the spot heating being performed by conducting electric current through the aluminum panel and the magnesium panel at the spot to be heated.

15. The method of claim 10 further comprising the punching of the rivet being performed by a punch movable in an annular housing and the spot heating of the magnesium panel being performed by conducting electric current to the anvil and to either the annular housing or the punch so that electric current is conducted through the metal panel and the magnesium panel.

16. The method of claim 10 further comprising the spot heating of the magnesium panel to a temperature of about 200 degrees Centigrade to improve the ductility of the magnesium panel.

17. A method to attach an aluminum panel to a magnesium panel comprising:
positioning the aluminum panel and the magnesium panel together with the magnesium panel supported on an anvil having a die cavity therein;
providing a punch that is movable in an annular housing above the aluminum panel;
spot heating the magnesium panel to a temperature of about 200 degrees Centigrade in the region of the die cavity.
and operating the punch to punch a steel self-piercing rivet through the aluminum panel and only part way into the magnesium panel, thereby displacing the spot heated magnesium into the die cavity and attaching together the panels with the interface between the steel rivet and the magnesium being concealed between the aluminum panel and the magnesium panel and protected from corrosion inducing environmental exposure.

18. The method of claim 17 further comprising said heating being performed by either one or both of electric resistance heating and induction heating.
